(19) United States
(12) Patent Application Publication
(10) Pub. No.: US 2013/0015172 A1
(43) Pub. Date: Jan. 17, 2013

(54) ELECTRIC HEATING DEVICE

(71) Applicant: YU-CHEN LIN, Pingtung County (TW)

(72) Inventor: YU-CHEN LIN, Pingtung County (TW)

(73) Assignees: YU-CHEN LIN, Pingtung County (TW); CHUAN-LIN WU, Tainan City (TW); CHING-TUN TSAI, Tainan City (TW)

(21) Appl. No.: 13/180,308

(22) Filed: Jul. 11, 2011

(51) Int. Cl. H05B 3/06

(52) U.S. Cl. 219/209

(57) ABSTRACT

A heating device is connected with an inlet and an outlet, and includes multiple heating units for providing heat energy to the water, at least one processing unit electrically connected to the heating units so as to adjust the heating units. Multiple sensors are connected close to the outlet and sense water flow and water temperature. A switch is electrically connected the sensors so activate the heating device. A power adjusting unit is connected to the processing unit and the switch so as to adjust electric voltage of the heating device. The switch is electrically connected with a power leakage sensor which shuts off the heating device when the power leakage sensor detects power leakage.

### FIELD OF THE INVENTION

The present invention relates to an electric heating device, and more particularly, to an electric heating device without need of storage of hot water and the temperature of each heating unit is set individually.

### BACKGROUND OF THE INVENTION

The conventional heating device for providing hot water generally uses gas which is burned and transfers heat to the cold water which is heated and provided to the users. However, the globe warming becomes a concern to the environment and the sources from which the gas or petroleum are developed are reduced. Therefore, the price of the gas increases rapidly which is a burden for most of the families.

Furthermore, the gas is burned by using oxygen and carbon monoxide is generated if the oxygen is not provided sufficiently and carbon monoxide is extremely dangerous to the users. The incomplete burning happens when the heating device is installed in a room or a place with poor ventilation.

Besides, the pressure of the water passing through the heating device may change the temperature that the water comes out from the shower head. The change of temperature of the water is a potential risk for the users.

The present invention intends to provide an electric heating device which improves the shortcomings of the conventional heating devices and provide stable and suitable hot water to the users.

### SUMMARY OF THE INVENTION

The present invention relates to a heating device that is connected with an inlet and an outlet, and includes multiple heating units for providing heat energy to the water, at least one processing unit electrically connected to the heating units so as to adjust the heating units. Multiple sensors are connected close to the outlet and sense water flow and water temperature. A switch is electrically connected the sensors so activate the heating device. A power adjusting unit is connected to the processing unit and the switch so as to adjust electric voltage of the heating device. The switch is electrically connected with a power leakage sensor which shuts off the heating device when the power leakage sensor detects power leakage.

Preferably, the at least one processing unit is a controlling member which controls and calculates thermo-energy of each of the heating units.

Preferably, the at least one processing unit is a power regulating member which regulates thermo-energy of each of the heating units.

Preferably, the switch is electrically connected with a power leakage sensor so as to shut off the heating device when the power leakage sensor detects power leakage.

The primary object of the present invention is to provide a safe and high efficient heating device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the flow chart of the heating device of the present invention;

FIG. 2 shows the first embodiment of the heating device of the present invention, and

FIG. 3 shows the second embodiment of the heating device of the present invention.

### DETAILED DESCRIPTION OF THE PREFERRED EMBODIMENT

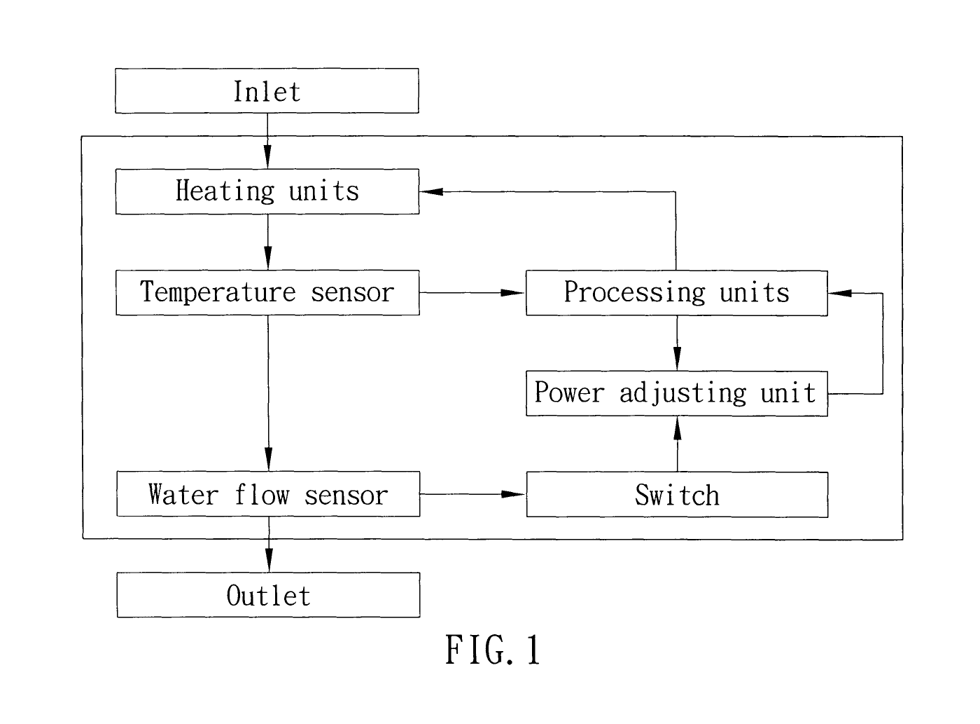

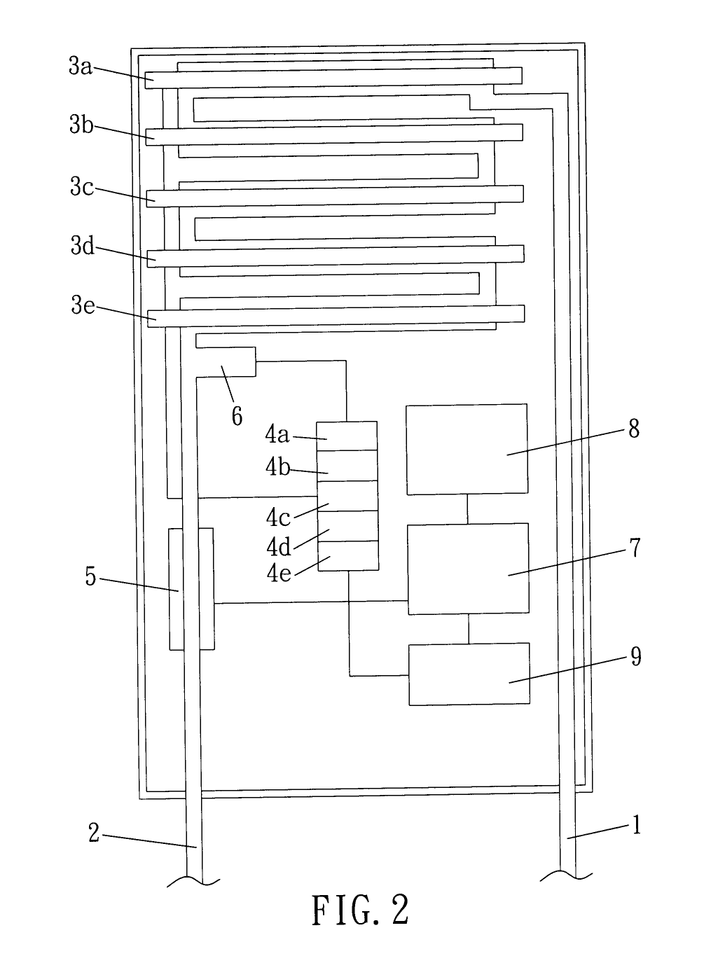

Referring to FIGS. 1 and 2, the first embodiment of the electric heating device of the present invention is connected to an inlet 1 and an outlet 2, wherein the inlet 1 is connected with a water source and the outlet 2 is connected with a faucet or a shower head (not shown) for example. The electric heating device comprises multiple heating units 3a-3e which are heating pipes in this embodiment so that water flows through the heating units 3a-3e and is heated therein. At least one processing unit which comprises five controlling members 4a-4e and are electrically connected to the heating units 3a-3e so as to control temperature of the heating units 3a-3e. The five controlling members 4a-4e control and calculate the thermo-energy of the heating units 3a-3e. At least two sensors such as the water flow sensor 5 and the temperature sensor 6 are installed close to the outlet 2, wherein the water flow sensor 5 senses the volume of the water flowing through the pipe communicating the outlet 2 and the temperature sensor 6 senses the water temperature of the water from the heating unit 3e that is located closest to the temperature sensor 6. A switch 7 has one end electrically connected the water flow sensor 5 and the temperature sensor 6 so as to activate the heating device. The other end of the switch 7 is connected to a power leakage sensor 8 which detects power leakage and shuts off the switch 7. A power adjusting unit 9 is connected to the controlling members 4a-4e and the switch 7 so as to adjust electric voltage of the heating device. The number of the heating units and the number of the controlling members the same, however, the two respective numbers are example and not restricted to limit the scope of the invention.

As shown in FIG. 2, when the users want to use hot water, the faucet or the shower head are turned on and the water source provides water to enter into the heating device via the inlet 1. The temperature sensor 6 senses the initial temperature of the water entering the heating units 3a-3e and the information is sent to the controlling members 4a-4e. The water flow sensor 5 senses the water flow and activates the switch 7 so that the heating device is operated. It is noted that the volume of the water entering from the inlet 1 has to reach a pre-set volume to activate the switch 7. The controlling members 4a-4e provided with proper voltage by the power adjusting unit 9 according the initial temperature and the heating units 3a-3e are operated to heat the water until a pre-set temperature is reached. The number of the heating units 3a-3e and the controlling members 4a-4e are the same, so that the heating units 3a-3e individually heat the water according the temperature that the water has. This is efficient and saves energy. Accordingly, the heating unit 3a that is located close to the inlet 1 provides the maximum heat energy to the water.

The temperature sensor 6 keeps on sensing the temperature of the water of the heating units 3a-3e and commands the power adjusting unit 9 to change the voltage provided to the controlling members 4a-4e. If the temperature of the water is too high and exceeds the pre-set temperature, the controlling members 4a-4e then provide the proper voltages to the heating units 3a-3e or even stops providing power to the heating units 3a-3e. Taken the embodiment as an example, there could be only three heating units 3c-3e are operated and the heating units 3a and 3b are shut off.

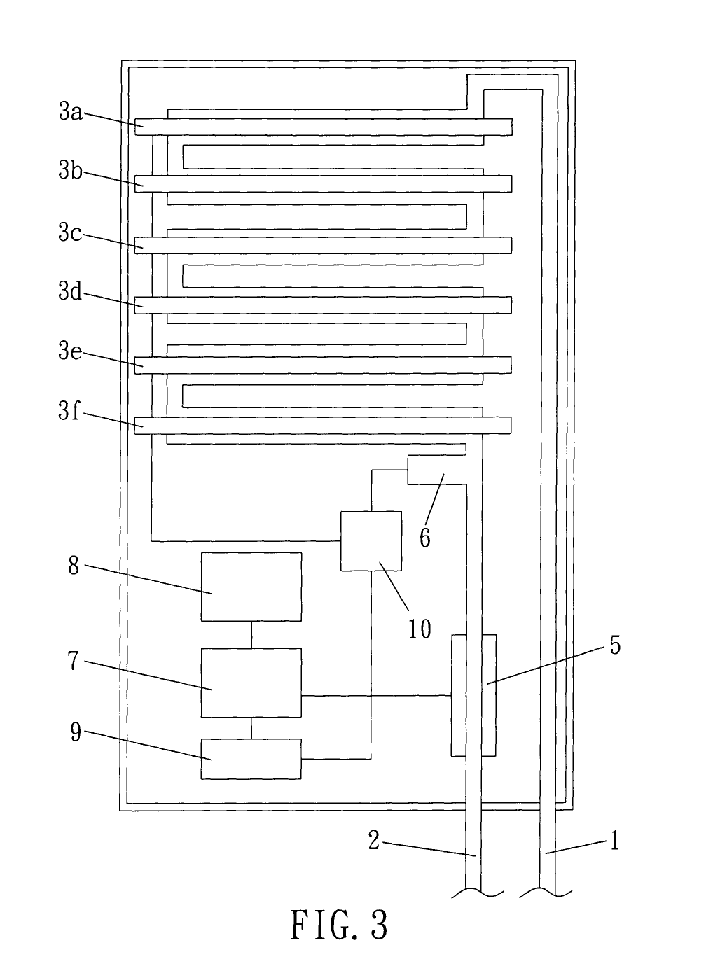

Referring to FIG. 3 which shows the second embodiment of the present invention and the difference between the first and second embodiments is that the piping system of the second embodiment is arranged to allocate the inlet 1 and the outlet 2 on the same side so as to install the power regulating member 10, and the number of the heating units is changed. The second embodiment has a set of heating unit 3f added so that there are six heating units in the second embodiment. The at least one processing unit is a power regulating member 10 which adjust the total power output and evenly regulates thermo-energy of each of the heating units 3a-3f.

When in use, the faucet or the shower head are turned on and the water source provides water to enter into the heating device via the inlet 1. The temperature sensor 6 senses the initial temperature of the water and the information of the initial temperature is sent to the power regulating member 10. The water flow sensor 5 senses the water flow and activates the switch 7 so that the heating device is operated. The power adjusting unit 9 provides proper voltage to the power regulating member 10 according to the initial temperature. The power regulating member 10 regulates the electric current and evenly provides the current to the heating units 3a-3f so that the water is heated to a desired temperature by the heating units 3a-3f.

The temperature sensor 6 keeps on sensing the temperature of the water heated by the heating units 3a-3e and commands the power adjusting unit 9 to change the voltage provided to the power regulating member 10 which adjusts the electric current to evenly provide the current to the heating units 3a-3f. If the temperature of the water is too high and exceeds the pre-set temperature, the power regulating member 10 then reduces the total electric current and evenly provides the electric current to the heating units 3a-3f. In other words, the six heating units 3a-3f are powered and the power regulating member 10 adjusts the total electric current to adjust the electric power to the heating units 3a-3f. Therefore, the thermo-energy that is provided to the water from the inlet 1 is adjusted to satisfy the user's need and save energy.

The heating device of the present invention can save energy by sensing the volume of the water coming from the outlet 2 and turning off the switch 7. Only when the users want to use hot water, the heating device is in function. Besides, once the temperature of the water exceeds the pre-set temperature, the power regulating member 10 adjusts the total electric current and the power adjusting unit 9 commands the controlling members 4a-4e to stop the operation of the heating units 3a-3e. The heating device is safe because the device is powered by electricity rather than by gas. The heating device is stable because the temperature sensor 6 keeps on checking the temperature of the water and the temperature can be adjusted by the processing unit and the heating units 3a-3e. Therefore, the water is kept at a constant temperature.

While we have shown and described the embodiment in accordance with the present invention, it should be clear to those skilled in the art that further embodiments may be made without departing from the scope of the present invention.

What is claimed is:

1. A heating device comprising:
multiple heating units;
at least one processing unit electrically connected to the heating units so as to adjust thermo-energy of the heating units;
multiple sensors for sensing water flow and water temperature;
a switch electrically connected the sensors, and
a power adjusting unit connected to the at least one processing unit and the switch so as to adjust electric voltage of the heating device.

2. The heating device as claimed in claim 1, wherein the at least one processing unit is a controlling member which controls and calculates thermo-energy of each of the heating units.

3. The heating device as claimed in claim 1, wherein the at least one processing unit is a power regulating member which regulates thermo-energy of each of the heating units.

4. The heating device as claimed in claim 1, wherein the switch is electrically connected with a power leakage sensor so as to shut off the heating device when the power leakage sensor detects power leakage.
